(19) United States
(12) Patent Application Publication
(10) Pub. No.: US 2013/0169800 A1
(43) Pub. Date: Jul. 4, 2013

(54) DISPLACEMENT MAGNITUDE DETECTION DEVICE FOR VEHICLE-MOUNTED CAMERA

(71) Applicant: Naoki Mori, Saitama (JP)

(72) Inventor: Naoki Mori, Saitama (JP)

(73) Assignee: HONDA MOTOR CO., LTD., MINATO-KU, TOKYO (JP)

(21) Appl. No.: 13/823,598

(22) PCT Filed: Nov. 9, 2011
(86) PCT No.: PCT/JP2011/075854

§ 371 Date: Mar. 14, 2013

(30) Foreign Application Priority Data
Nov. 16, 2010 (JP) 2010-256096

(51) Int. Cl. H04N 5/232

(52) U.S. Cl. CPC H04N 5/23254
USPC 348/135

(57) ABSTRACT

A displacement magnitude calculation device for a vehicle-mounted camera includes a reference value calculating unit 12 which divides, a region for measurement Ea into a plurality of measurement unit regions D0 to DN, calculates an average of a luminance value of pixels inside each measurement unit region as reference values re(0,t), re(1,t), . . . , re(N,1) of each measurement unit region, and sets a luminance vector VEC(t) indicating a distribution manner in a vertical direction of each reference value, and a camera displacement magnitude calculating unit 13 which calculates a degree of correlation between a luminance vector VEC(t₁) at t₁ and a luminance vector VEC(t₂) at t₂ by shifting the vertical luminance vector VEC(t₂) in a vertical direction (y direction), and obtains the displacement magnitude of the camera 20 from t₁ to t₂, on the basis of a shift amount in which the degree of correlation became the highest.

### TECHNICAL FIELD

The present invention relates to a device which detects a displacement magnitude of a vehicle-mounted camera, on the basis of an image taken by the vehicle-mounted camera.

### BACKGROUND ART

As a technique of detecting a displacement magnitude of a camera, for example, a technique of setting a shake detecting area in an imaging screen of a camera for correcting the shaking of the screen by the fluctuation of the camera, detecting a center-of-gravity position of a brightness of the shake detecting area in each time-series captured image, and obtaining a displacement magnitude of the camera from fluctuation by a change in the center-of-gravity position (for example, refer to Patent Document 1).

### PRIOR ART DOCUMENT

### Patent Document

Patent Document 1: Japanese Patent Application Laid-Open No. H4-287579

### SUMMARY OF THE INVENTION

### Problem to be Solved by the Invention

In a case of detecting a displacement magnitude of a vehicle-mounted camera using the technique disclosed in Patent Document 1, an imaging target within the shake detecting area in each time-series image taken by the camera becomes different during a traveling of the vehicle, by receiving an influence especially from a vertical rocking (pitching) of the vehicle.

In this case, when the center-of-gravity position of the brightness of the shake detecting area in each captured image corresponds to an imaging portion of a different object, there is an inconvenience that the displacement magnitude of the camera cannot be detected accurately.

The present invention has been made in view of such background, and aims at providing a displacement magnitude detection device for a vehicle-mounted camera capable of detecting a displacement magnitude of the vehicle-mounted camera accurately from the captured image of the vehicle-mounted camera.

### Means for Solving the Problem

The present invention has been made in view of achieving the above-mentioned object, and includes a reference value calculating unit which divides, in an image taken by the vehicle-mounted camera, a predetermined region for measurement into a plurality of measurement unit regions having a width of a predetermined number of pixels in a specific direction which corresponds to a perpendicular direction in real space, and calculates a sum or an average of a luminance value or a saturation value of pixels inside each measurement unit region as a reference value of each measurement unit region; and a camera displacement magnitude calculating unit which calculates a degree of correlation between a first distribution manner and a second distribution manner, the first distribution manner being a distribution manner in the specific direction of each reference value calculated by the reference value calculating unit for a first image taken by the camera, and the second distribution manner being a distribution manner in the specific direction of each reference value calculated by the reference value calculating unit for a second image taken by the camera at a time point different from the first image, by shifting the first distribution manner or the second distribution manner in the specific direction, and calculates the displacement magnitude of the camera between an imaging time point of the first image and an imaging time point of the second image, on the basis of a shift amount in which the degree of correlation becomes the highest (a first aspect of the invention).

According to the first aspect of the invention, the reference value calculating unit calculates the reference value of each measurement unit region of the region for measurement, for the image taken by the camera. The reference value indicates an overall tendency of the luminance or the saturation of each measurement unit region, and since each measurement unit region is obtained by dividing the region for measurement with a width in the specific direction, the dispersion manner of each reference value in the specific direction shows the overall dispersion manner of the luminance or the saturation of the region for measurement in the specific direction.

Thereafter, the camera displacement magnitude calculating unit calculates the degree of correlation between the first distribution manner for the first image and the second distribution manner for the second image, that are calculated with respect to the first image and the second image taken at different time points, by shifting the first distribution manner or the second distribution manner in the specific direction. Further, the camera displacement magnitude calculating unit calculates the displacement magnitude of the camera, on the basis of the shift amount in which the degree of correlation becomes the highest.

In this case, the first distribution manner and the second distribution manner indicate the distribution manner of the overall luminance or saturation within the region for measurement. Therefore, the camera displacement magnitude calculating unit may calculate the shift amount in the specific direction of an imaged object within the region for measurement while reducing the influence of a change of an imaging target of the region for measurement between the first image and the second image by the displacement of the camera. Further, since the specific direction corresponds to the perpendicular direction in the real space, the camera displacement magnitude calculating unit may calculate the displacement magnitude of the camera in the perpendicular direction accurately on the basis of the shift amount.

Further, in the first aspect of the invention, the camera includes a road in front of a vehicle mounted with the camera as an imaging range, and the region for measurement is set according to a position of an image portion of the road in an image taken by the camera (a second aspect of the invention).

According to the second aspect of the invention, by setting the region for measurement including the image portion of the road in which the distribution of the luminance or the saturation is stable, it becomes possible to increase the accuracy of the displacement magnitude of the camera calculated by the camera displacement magnitude calculating unit.

Further, in the second aspect of the invention, a region for measurement changing unit which changes the region for measurement according to the position of the image portion of the road, or a position of an image portion of an existing object in a surroundings of the road, in the image taken by the camera, is further included (a third aspect of the invention).

According to the third aspect of the invention, the region for measurement changing unit performs the processing of changing the region for measurement so as to increase a proportion of the image portion of the road within the region for measurement, according to the position of the image portion of the road, or the position of the image portion of the existing object in the surroundings of the road in the image taken by the camera, or change the region for measurement to exclude the image portion of the other vehicle, and the like. By changing the region for measurement as such, it becomes possible to suppress the accuracy of the displacement magnitude of the camera calculated by the camera displacement magnitude calculating unit from dropping, from the influence of the image portion other than the image portion of the road.

### BRIEF DESCRIPTION OF DRAWINGS

FIG. 1 is an explanatory view of a fixing mode of a camera and a vehicle travel assistance device to a vehicle;

FIG. 2 is a configuration view of the vehicle travel assistance device;

FIG. 3 is a flow chart of a calculating processing of a vertical luminance vector in the vehicle travel assistance device;

FIG. 4 is an explanatory view of the vertical luminance vector;

FIG. 5 is an explanatory view of a processing of calculating a displacement magnitude of the camera, from a degree of correlation of the vertical luminance vector in time-series images; and

FIG. 6A and FIG. 6B are explanatory views of an example of changing a region for measurement.

### MODE FOR CARRYING OUT THE INVENTION

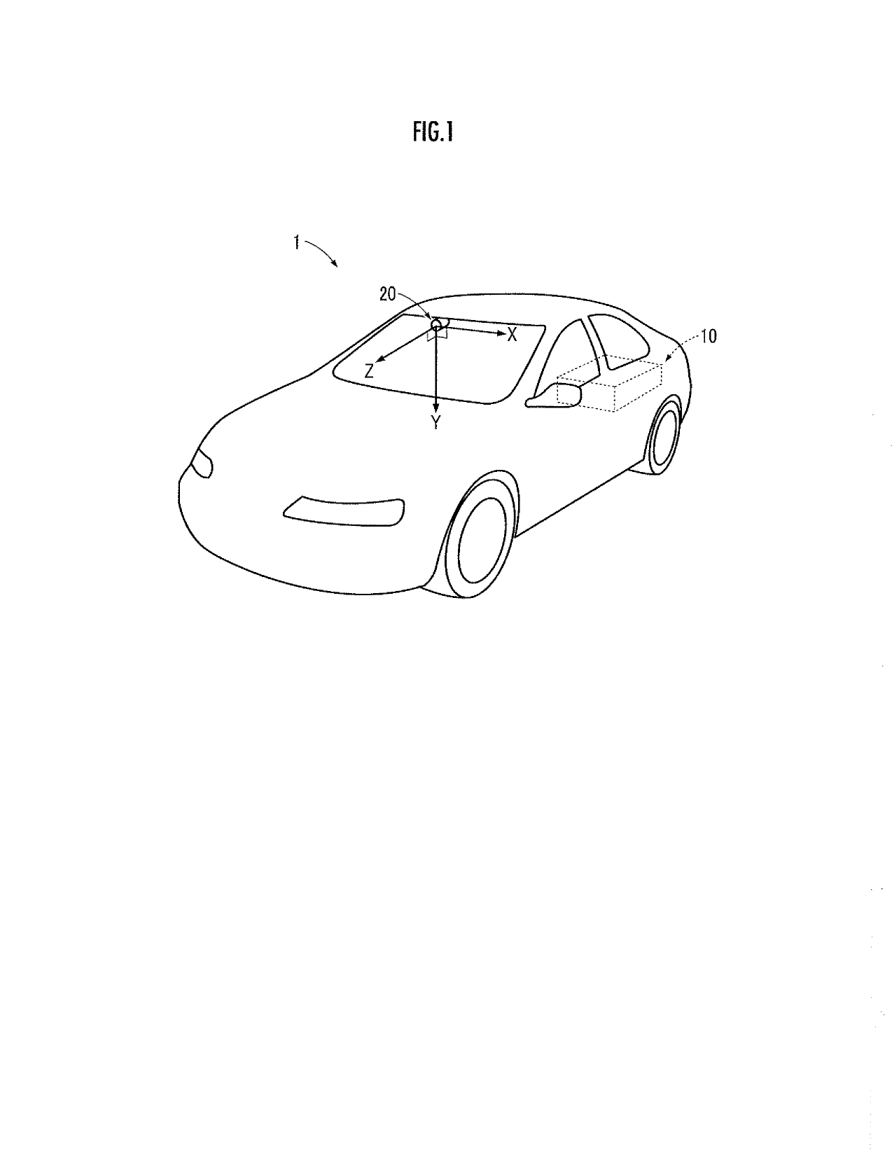

An embodiment of the present invention will be explained with reference to FIG. 1 through FIG. 5. With reference to FIG. 1, in the present embodiment, a displacement magnitude detection device for a vehicle-mounted camera of the present invention is configured as a part of a function of a vehicle travel assistance device 10 mounted on a vehicle 1 (self vehicle). A camera 20 (a vehicle-mounted camera) and the vehicle travel assistance device 10 are mounted to the vehicle 1.

The camera 20 is fixed to inside of the vehicle, so as to image a front of the vehicle 1 through a windshield, and a real space coordinate system taking a fixing portion of the camera 20 as an origin, a lateral direction of the vehicle 1 (vehicle width direction) as an X axis, an up-down direction (perpendicular direction) as a Y axis, and an anteroposterior direction (traveling direction) as a Z axis, is defined.

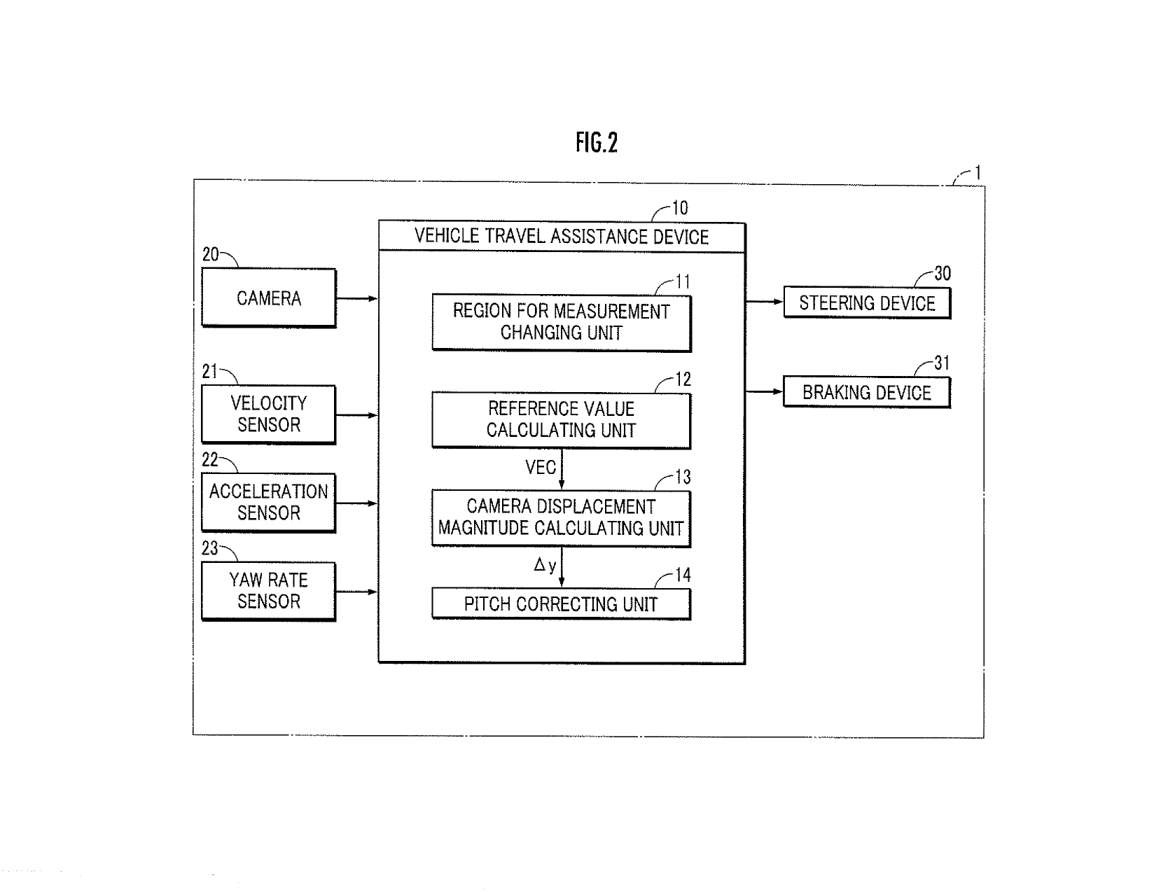

With reference to FIG. 2, the vehicle 1 is equipped with, in addition to the vehicle travel assistance device 10, a velocity sensor 21, an acceleration sensor 22, a yaw rate sensor 23, a steering device 30, and a braking device 31. The velocity sensor 21 outputs a detection signal of a velocity of the vehicle 1, the acceleration sensor 22 outputs a detection signal of an acceleration of the vehicle 1, and the yaw rate sensor 23 outputs a detection signal of a yaw rate of the vehicle 1.

The vehicle travel assistance device 10 is an electronic unit configured from a CPU, a memory and the like, and is input with a video signal from the camera 20 and the detection signals from each sensors 21, 22, 23. The vehicle travel assistance device 10 has a function of detecting a displacement magnitude of the camera 20 in the Y-axis direction accompanying a rocking of the vehicle in the up-down direction, and correcting (pitch compensating) an offset of an image taken by the camera 20, and the configuration of detecting the displacement magnitude corresponds to the displacement magnitude detection device for the vehicle-mounted camera of the present invention.

The vehicle travel assistance device 10 functions as, by making the CPU execute control programs for vehicle travel assistance stored in the memory, a region for measurement changing unit 11, a reference value calculating unit 12, a camera displacement magnitude calculating unit 13, and a pitch compensating unit 14, that are configurations for performing the pitch compensation. The vehicle travel assistance device 10 performs the pitch compensation to the image taken by the camera 20, detects a lane mark provided on a road from the image after the pitch compensation, and recognizes a traveling lane of the vehicle 1.

The vehicle 1 is further mounted with the steering device 30 and the braking device 31, and the vehicle travel assistance device 10 executes a travel assistance control of preventing the vehicle 1 from departing from the traveling lane, by controlling one of or both of the operation of the steering device 30 and the braking device 31.

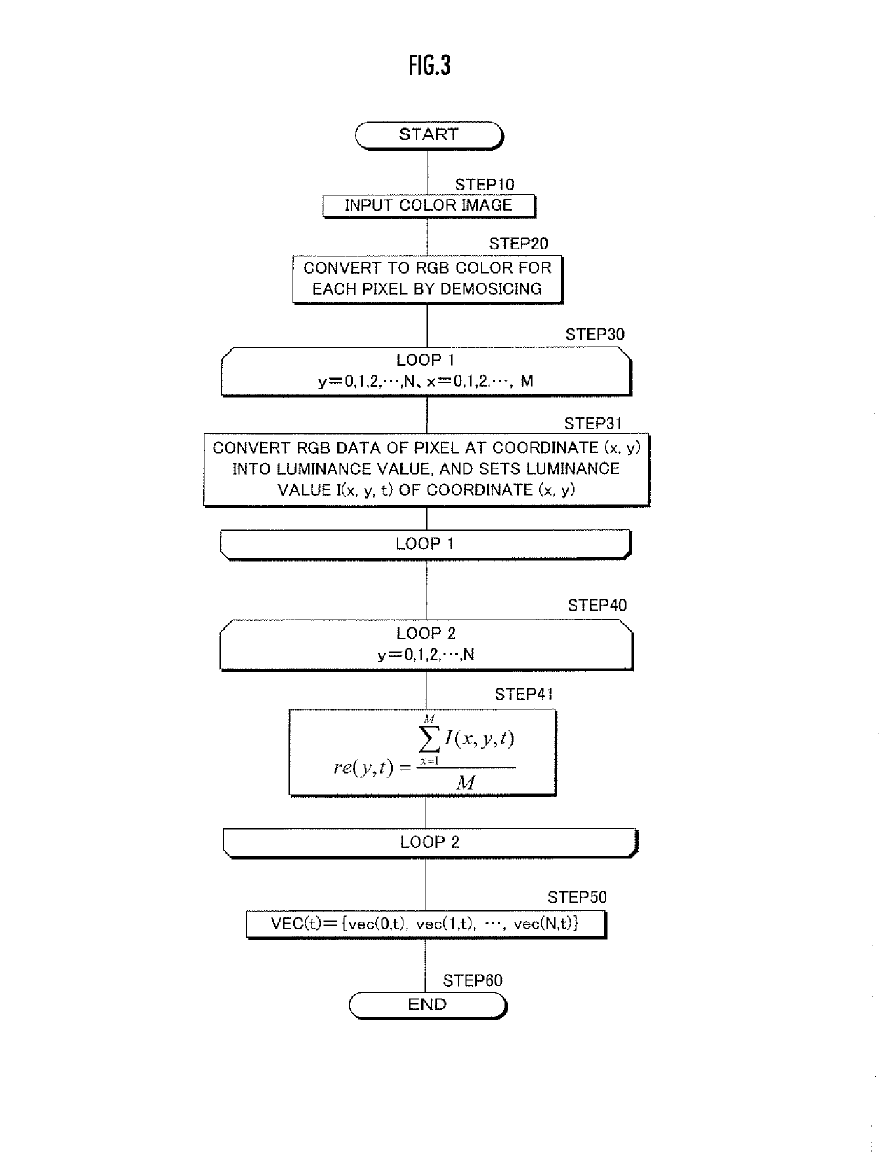

Next, according to a flow chart shown in FIG. 3, a processing by the reference value calculating unit 12 will be explained. The vehicle travel assistance device 10 inputs the image (color image) taken by the camera 20 in STEP 10, and calculates data of an RGB color of each pixel by performing demosaicing to the output of the pixels of the camera 20 and in STEP 20. The demosaicing in STEP 20 is performed since the camera 20 of the present embodiment uses an imaging element of a single chip of a Bayer array. However, the demosaicing process is unnecessary in a case where a camera using an imaging element of three-chip RGB independent type.

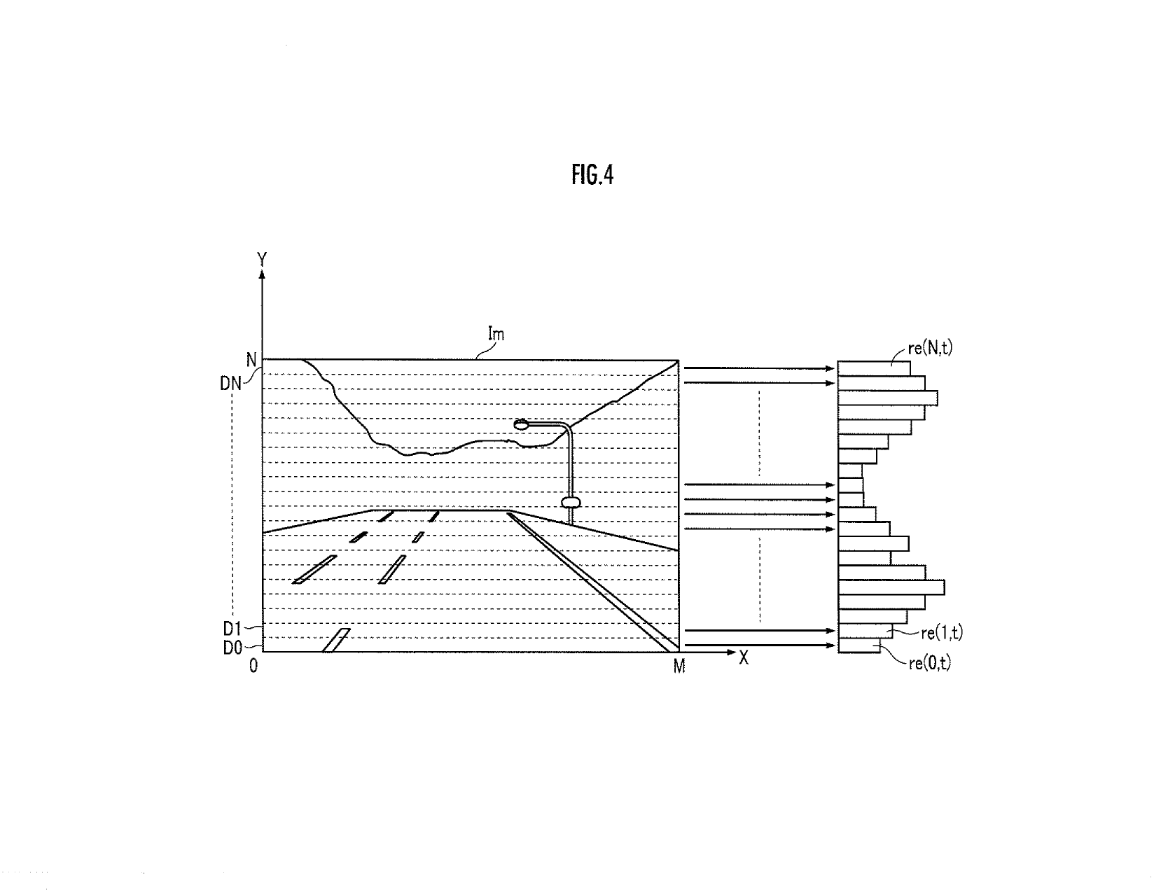

STEP30 through STEP50 are processing by the reference value calculating unit 12. The image taken by the camera 20 is, as is shown in FIG. 4, the image Im of (N+1)* (M+1) pixels, with a vertical coordinate (y coordinate) of 0 to N (pixel), and a horizontal coordinate (x coordinate) of 0 to M (pixel). The y-axis direction corresponds to the specific direction of the present invention, which corresponds to the perpendicular direction in the real space.

The reference value calculating unit 12 executes a loop 1 in STEP30, and converts the R, G, and B data of the pixel of each coordinate (x, y) (x=0, 1, 2, . . . , M, y=0, 1, 2, . . . N) of the image Im to a luminance value, and sets the luminance value I (x, y, t) (t represents an imaging time point) of each pixel. Here, one of the R, G, and B data of each pixel may be selected and used instead of the luminance value of each pixel.

In a loop in subsequent STEP 40, the reference value calculating unit 12 divides the image Im into N+1 measurement unit regions D0 to DN, each region having the same y coordinate and x coordinate of 0 to M, and having 1*(M+1) pixels. Here, the width of the measurement unit region in y-axis direction may not be one pixel (one line), but may be a plurality of pixels.

Thereafter, the reference value calculating unit 12 calculates an average value of the luminance value of the pixels in each measurement unit region, using the following equation (1), as a reference value re (y,t) (y=0, 1, . . . , N, t is a time of imaging of the image Im) of each measurement unit region.

$$\begin{matrix}[ Equation 1 ] & \\ re ( y , t ) = \frac{{\sum }_{x = 0}^{M} I ( x , y , t )}{M + 1} \\ y = 0 , 1 , 2 , Λ , N & ( 1 )\end{matrix}$$

In subsequent STEP 50, the reference value calculating unit 12 sets, among the reference values re(y,t) (y=0, 1, 2, . . . , N) of each measurement unit region, a vertical luminance vector VEC(t) of the following equation (2) which has a component in a range narrower than N (s˜s+w, 1<s, w<N) by a shift amount (for example, a maximum of 30 pixels) to be explained later, proceeds to STEP60, and ends the processing.

[Equation 2]

VEC(t)={re(s,t),ve(s+1,t),re(s+2,t),Λ,re(s+w,t)} (2)

With the processing explained above, the reference value calculating unit 12 sets the vertical luminance vector VEC(t), to the image Im sequentially taken (for example, every 33 msec) by the camera 20. The vertical luminance vector VEC(t) shows a distribution manner of the reference values re(y, t) in the vertical direction (y direction) in a range of y=s to s+w.

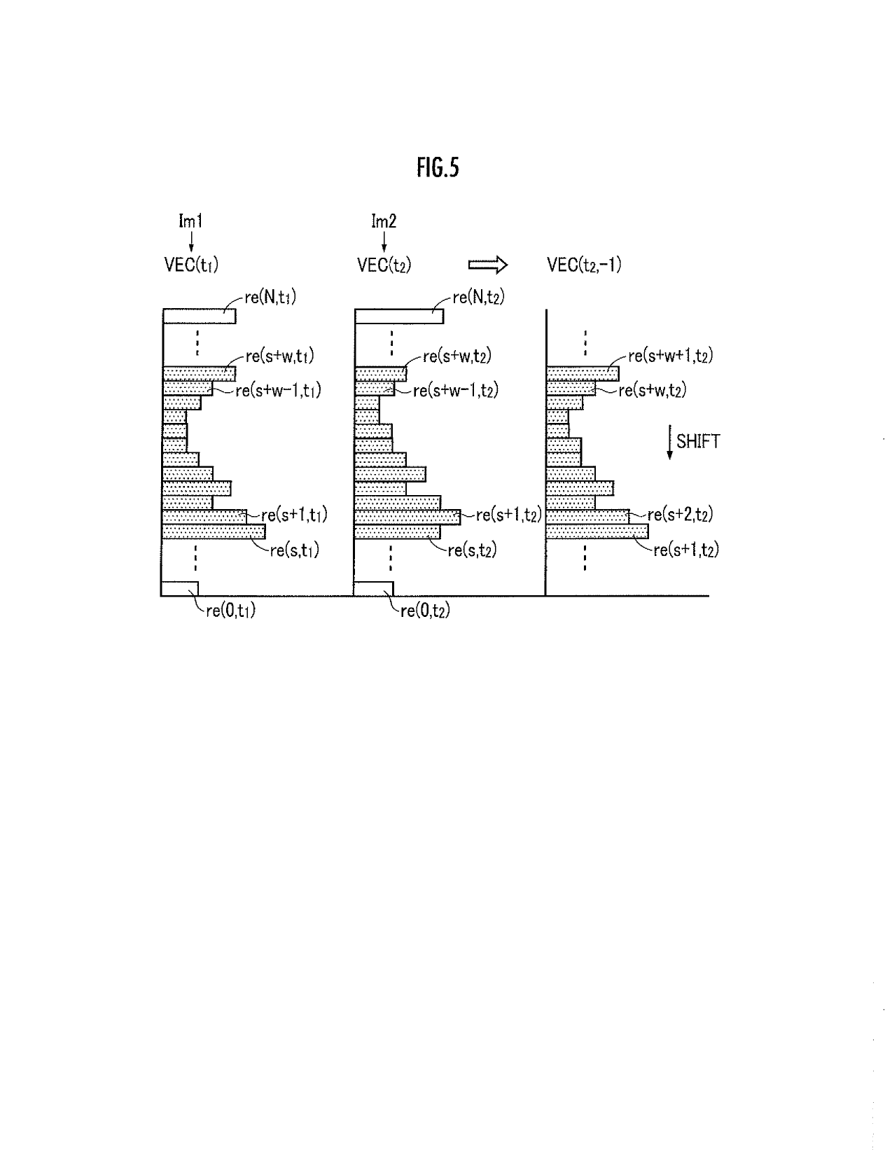

Thereafter, as is shown in FIG. 5, the camera displacement magnitude calculating unit 13 obtains the displacement magnitude of the camera 20 in the vertical direction (Y direction), by obtaining a degree of correlation between a luminance vector VEC(t₁) of an image Im1 and a luminance vector VEC(t₂) of an image Im2, that are calculated for the images Im1 and Im2 taken at different time points t₁, t₂ (=t₁+33 msec), by shifting the components of the luminance vector VEC(t₂) in the y direction.

In FIG. 5, the distribution of the components of VEC(t₂) has a tendency of shifting the distribution of the components of VEC(t₁) upwards. Therefore, it can be estimated that the position of the camera 20 at t₂ has displaced downwards with respect to the position of the camera 20 at t₁.

As is shown in the following equation (3), the camera displacement magnitude calculating unit 13 sequentially obtains a luminance vector VEC (t₂, i) (i is a shift value, i=±1, ±2, . . . , + denoting an up shift, and − denoting a down shift) obtained by shifting the luminance vector VEC(t₂) in the up-down direction within a predetermined shift range, and calculates the degree of correlation with the luminance vector VEC(t₁).

[Equation 3]

VEC(t,i)={re(s+i,t),re(s+1+i,t),re(s+2+i,t),Λ,re(s+w+i,t)} (3)

In FIG. 5, a luminance vector VEC(t₂,−1) shifted downwards by one pixel is shown as an example. As is explained above, the camera displacement magnitude calculating unit 13 calculates the degree of correlation with the luminance vector VEC(t₁) of the first image Im1, by sequentially calculating VEC(t₂, i) by shifting the luminance vector VEC(t₂) of the second image Im2 up and down by i.

Thereafter, on the basis of the shift value i in which the degree of correlation with the luminance vector VEC(t₁) of the first image Im1 becomes the highest, the camera displacement magnitude calculating unit 13 calculates a displacement magnitude Δy of the camera 20 in the vertical direction between t₁ and t₂. The displacement magnitude Δy of the camera 20 is proportional to the shift value i.

The pitch compensating unit 14 performs the correction of shifting (the pitch compensation) to compensate for the displacement magnitude Δy of the camera 20 with respect to the second image Im2, and the vehicle travel assistance device 10 performs a detecting processing of an image portion of an object of the lane mark, with respect to the second image Im2 after performing the pitch compensation. By doing so, it becomes possible to prevent a transition of detected positions of the lane mark between the first image and the second image from being offset from an original position, from an influence of a pitching (rocking in the perpendicular direction) of the vehicle 1. Further, it becomes possible to prevent a recognition accuracy of the position of the lane mark from dropping by the offset.

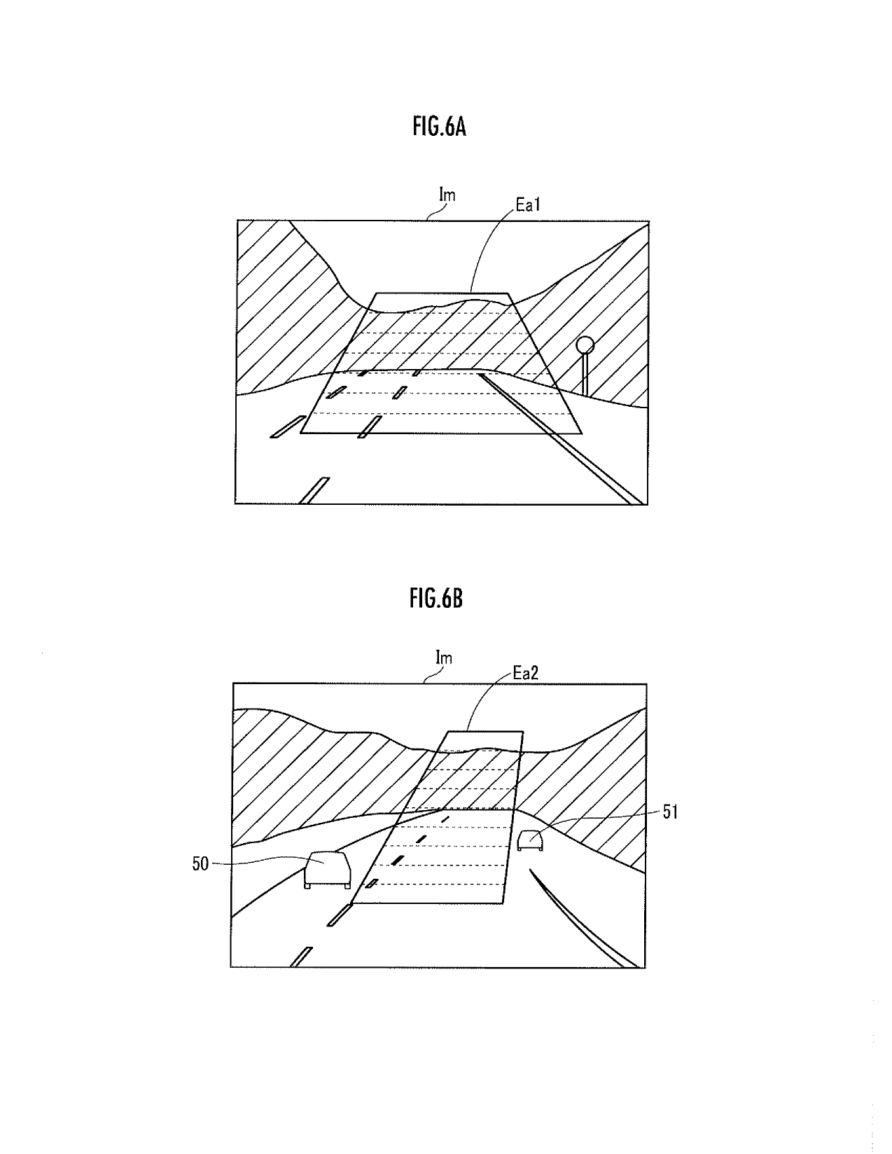

In the present embodiment, the measurement unit region D (D0 to DN) is set taking a whole of the image Im taken by the camera 20 as the region for measurement, as shown in FIG. 4. However, a region for measurement Ea1 having a trapezoidal shape to match the image portion of a road may be set by the region for measurement changing unit 11, as is shown in FIG. 6A.

By setting the region for measurement Ea1 this way, it becomes possible to obtain the luminance vector VEC while avoiding the influence of traffic signs, buildings and the like existing in a surroundings of the road.

Further, when an image portion of an object close to the vehicle 1 is used when obtaining the pitch amount of the camera 20, a displacement of the image portion becomes larger with respect to a slight pitching of the vehicle 1, so that there are cases where an error in the displacement magnitude detection of the camera 20 becomes large. Therefore, by setting the region for measurement Ea1 so as to include a vicinity of a horizon far away from the vehicle 1, it becomes possible to increase the detection accuracy of the displacement magnitude of the camera 20.

Further, as is shown in FIG. 6B, when it is detected that image portions 50, 51 of other vehicles are included in the image Im taken by the camera 20, the region for measurement changing unit 11 may change to a region for measurement Ea2 in which these image portions are removed.

Further, in the present embodiment, the luminance vector VEC is calculated using the luminance of each pixel in the image Im taken by the camera 20. However, a vector of saturation may be calculated using saturation of each pixel in the image Im, and the displacement magnitude of the camera may be obtained by calculating the degree of correlation between the saturation vectors of the captured images taken at different time points.

Further, in the present embodiment, the average value of the luminance value of each pixel in each measurement unit region is set as the reference value of each measurement unit region, by the above-mentioned equation (1). However, a total value of the luminance value of the pixels of each measurement unit region may be set as the reference value of each measurement unit region.

Further, the average value and the total value may be used separately in the region for measurement. For example, the reference value may be calculated using the total value in an upper half of the region for measurement, and the reference value may be calculated using the average value in a lower half of the region for measurement. Also, both of the reference values using the average value and the reference value using the total value may be calculated, and the one with a larger amount of characteristics (one in which a peak of a luminance profile by the luminance vector becomes larger) may be adopted.

Further, in the present embodiment, when calculating the degree of correlation between the luminance vectors of the images taken at different time points, the camera displacement magnitude calculating unit 13 shifted the luminance vector by a unit of one pixel in the up-down direction. However, it is possible to improve the calculation accuracy of the displacement magnitude, by shifting the luminance vector by a unit less than 1 (for example, a unit of 0.1 pixel). In this case, a processing of sequencing (subpixeling) a discrete function in the above-mentioned equation (2) with a technology of a spline interpolation and the like.

Further, in the present embodiment, an example using the color camera 20 is used is shown. However, the camera may be a black-and-white camera. In a case where the black-and-white camera is used, the processing of converting the color component into the luminance value by STEP20 and the loop 1 in STEP30 in FIG. 3 becomes unnecessary.

### INDUSTRIAL APPLICABILITY

As is explained above, according to the displacement magnitude detection device for the vehicle-mounted camera of the present invention, it becomes possible to accurately detect the displacement magnitude of the vehicle-mounted camera, from the image taken by the vehicle-mounted camera. Therefore, it is useful in performing the pitch compensation to the image taken by the vehicle-mounted camera.

### REFERENCES

1 . . . vehicle, 10 . . . vehicle travel assistance device, 11 . . . region for measurement changing unit, 12 . . . reference value calculating unit, 13 . . . camera displacement magnitude calculating unit, 14 . . . pitch compensating unit, 20 . . . camera, 21 . . . velocity sensor, 22 . . . acceleration sensor, 23 . . . yaw rate sensor, 30 . . . steering device, 31 . . . braking device.

1. A displacement magnitude detection device for a vehicle-mounted camera, comprising:
a reference value calculating unit which divides, in an image taken by the vehicle-mounted camera, a predetermined region for measurement into a plurality of measurement unit regions having a width of a predetermined number of pixels in a specific direction which corresponds to a perpendicular direction in real space, and calculates a sum or an average of a luminance value or a saturation value of pixels inside each measurement unit region as a reference value of each measurement unit region; and
a camera displacement magnitude calculating unit which calculates a degree of correlation between a first distribution manner and a second distribution manner, the first distribution manner being a distribution manner in the specific direction of each reference value calculated by the reference value calculating unit for a first image taken by the camera, and the second distribution manner being a distribution manner in the specific direction of each reference value calculated by the reference value calculating unit for a second image taken by the camera at a time point different from the first image, by shifting the first distribution manner or the second distribution manner in the specific direction, and calculates the displacement magnitude of the camera between an imaging time point of the first image and an imaging time point of the second image, on the basis of a shift amount in which the degree of correlation becomes the highest.

2. The displacement magnitude detection device for the vehicle-mounted camera according to claim 1,
wherein the camera includes a road in front of a vehicle mounted with the camera as an imaging range, and
the region for measurement is set according to a position of an image portion of the road in an image taken by the camera.

3. The displacement magnitude detection device for the vehicle-mounted camera according to claim 2,
wherein the device comprises a region for measurement changing unit which changes the region for measurement according to the position of the image portion of the road, or a position of an image portion of an object in a surroundings of the road, in the image taken by the camera.
